(19) United States
(12) Patent Application Publication
(10) Pub. No.: US 2016/0080076 A1
(43) Pub. Date: Mar. 17, 2016

(54) COMMUNICATION SYSTEM, ELECTRONIC DEVICE, ELECTRONIC TIMEPIECE, COMMUNICATION METHOD

(71) Applicant: SEIKO INSTRUMENTS INC., Chiba-shi (JP)

(72) Inventors: Tomohiro IHASHI, Chiba-shi (JP); Kenji OGASAWARA, Chiba-shi (JP); Akira TAKAKURA, Iwate-gun Iwate (JP); Kazumi SAKUMOTO, Chiba-shi (JP); Tamotsu MAESAWA, Chiba-shi (JP); Kazuhiro KOYAMA, Chiba-shi (JP); Kosuke YAMAMOTO, Chiba-shi (JP); Ayumi MATSUMOTO, Chiba-shi (JP)

(21) Appl. No.: 14/854,947

(22) Filed: Sep. 15, 2015

(30) Foreign Application Priority Data
Sep. 17, 2014 (JP) 2014-189260

(51) Int. Cl. H04B 10/079; H04B 10/116

(52) U.S. Cl. CPC H04B 10/0795; H04B 10/116

(57) ABSTRACT

To receive data normally in communication by an optical signal by an electronic device which transmits data even when a transmission frequency differs. An electronic device transmits a transmission-frequency measurement signal for measuring a transmission frequency of data and transmits the data by using a light source which transmits an optical signal. An electronic timepiece specifies the transmission frequency of data based on the transmission-frequency measurement signal received by a solar battery which receives the optical signal and receiving the data by the solar battery based on the specified transmission frequency.

### BACKGROUND OF THE INVENTION

1. Field of the Invention

The present invention relates to a communication system, an electronic device, an electronic timepiece, and a communication method.

2. Description of Related Art

There exists a system which performs data transmission by changing brightness (color) of a display of an electronic device and receives the data by a solar panel (for example, refer to JP-A-2014-048136 (Patent Document 1)). In such system, it is necessary that a transmission frequency of data corresponds to a refresh rate of an electronic device which transmits data. Generally, the refresh rate which indicates the frequency of scanning or rewriting of a display, namely, the number of refresh times per a unit time normally by using Hertz (Hz) as a unit is approximately 60 Hz, however, the refresh rate slightly differs according to electronic devices in actuality. For example, the refresh rate of a smartphone display varies from 50 Hz to 60 Hz. Furthermore, there is a case where the refresh rate is decreased to 30 Hz from the normal 60 Hz for reducing power consumption of a terminal.

### SUMMARY OF THE INVENTION

However, in the technique described in Patent Document 1, there is a problem that it is difficult to specify the frequency with which data is received in the device which receives data in the case where the transmission frequency differs according to electronic devices which transmit data, which may inhibit normal reception of data. For example, in a certain kind of device having a refresh rate of 58 Hz, the transmission frequency based on 58 Hz is used, and in another kind of device having a refresh rate of 60 Hz, the transmission frequency based on 60 Hz is used. The problem is solved in a clock synchronization type, however, it is difficult to create a clock when data transmission is performed by the brightness of light.

The present invention has been made in view of the above problems and an object thereof is to provide a communication system, an electronic device, a communication method and a program capable of receiving data normally in communication by the optical signal even when the transmission frequency differs according to the electronic devices which transmit data.

According to an embodiment of the present invention, there is provided a communication system including a first electronic device and a second electronic device, in which the first electronic device has a transmission part transmitting an optical signal, and a controller transmitting a transmission-frequency measurement signal for measuring a transmission frequency of data from the transmission part and transmitting the data from the transmission part, and the second electronic device has a receiving part receiving the optical signal and a controller specifying the transmission frequency of the data based on the transmission-frequency measurement signal received by the receiving part and receiving the data by the receiving part based on the specified transmission frequency.

In the communication system according to the embodiment of the present invention, the transmission-frequency measurement signal may be a signal having the same cycle as the data.

Also in the communication system according to the embodiment of the present invention, the controller of the first electronic device may transmit a communication start signal notifying the start of communication before transmitting the transmission-frequency measurement signal from the transmission part.

Also in the communication system according to the embodiment of the present invention, the transmission-frequency measurement signal may be a signal of 2 or more bits in which “0” and “1” are repeated in each bit, and the controller may specify the transmission frequency by using the 2-bit signal as a unit.

According to the embodiment of the present invention, there is provided an electronic device including a transmission part transmitting an optical signal and a controller transmitting a transmission-frequency measurement for measuring the transmission frequency of data from the transmission part and transmitting the data from the transmission part.

According to the embodiment of the present invention, there is provided an electronic timepiece including a receiving part receiving an optical signal including time data and a controller specifying a transmission frequency of data including time data transmitted from another electronic device based on a transmission-frequency measurement signal for measuring a transmission frequency received by the receiving part and receiving the data based on the specified transmission frequency by the receiving part to correct time by the data.

Also according to the embodiment of the present invention, there is provided a communication method in a communication system including a first electronic device and a second electrode device including the steps of performing control to transmit a transmission-frequency measurement signal for measuring a transmission frequency of data and to transmit the data by using a transmission part which transmits an optical signal by the first electronic device and performing control to specify the transmission frequency of the data based on the transmission-frequency measurement signal received by a receiving part which receives the optical signal and to receive the data by the receiving part based on the specified transmission frequency by the second electronic device.

Also according to the embodiment of the present invention, there is provided a program allowing a computer to execute the step of performing control to transmit a transmission-frequency measurement signal for measuring a transmission frequency of data and to transmit the data by using a transmission part which transmits an optical signal.

Also according to the embodiment of the present invention, there is provided a program allowing a computer to execute the step of performing control to specify a transmission frequency of data transmitted from another electronic device based on a transmission-frequency measurement signal for measuring the transmission frequency received by a receiving part which receives an optical signal and to receive the data by the receiving part based on the specified transmission frequency.

In the present invention, the controller of the first electronic device transmits the transmission-frequency measurement signal for measuring the transmission frequency of data from the transmission part and transmits the data from the transmission part. The controller of the second electronic device specifies the transmission frequency of data based on the transmission-frequency measurement signal received by the receiving part which receives the optical signal and receives data by the receiving part based on the specified transmission frequency. Accordingly, it is possible to automatically specify the transmission frequency of data received by the second electronic device as the receiving side in the communication by the optical communication. Therefore, the second electronic device can receive data normally.

### BRIEF DESCRIPTION OF THE DRAWINGS

FIG. 1 is a schematic view showing a configuration of a communication system according to an embodiment of the present invention;

FIG. 2 is a timing chart for explaining an operation example of an electronic device according to the embodiment of the present invention;

FIGS. 3A and 3B are views for explaining an operation example of an electronic timepiece according to the embodiment of the present invention;

FIG. 4 is a flowchart showing a processing procedure of communication processing executed by the electronic device according to the embodiment of the present invention; and

FIG. 5 is a flowchart showing a processing procedure of communication processing executed by the electronic timepiece according to the embodiment of the present invention.

### DESCRIPTION OF EMBODIMENTS

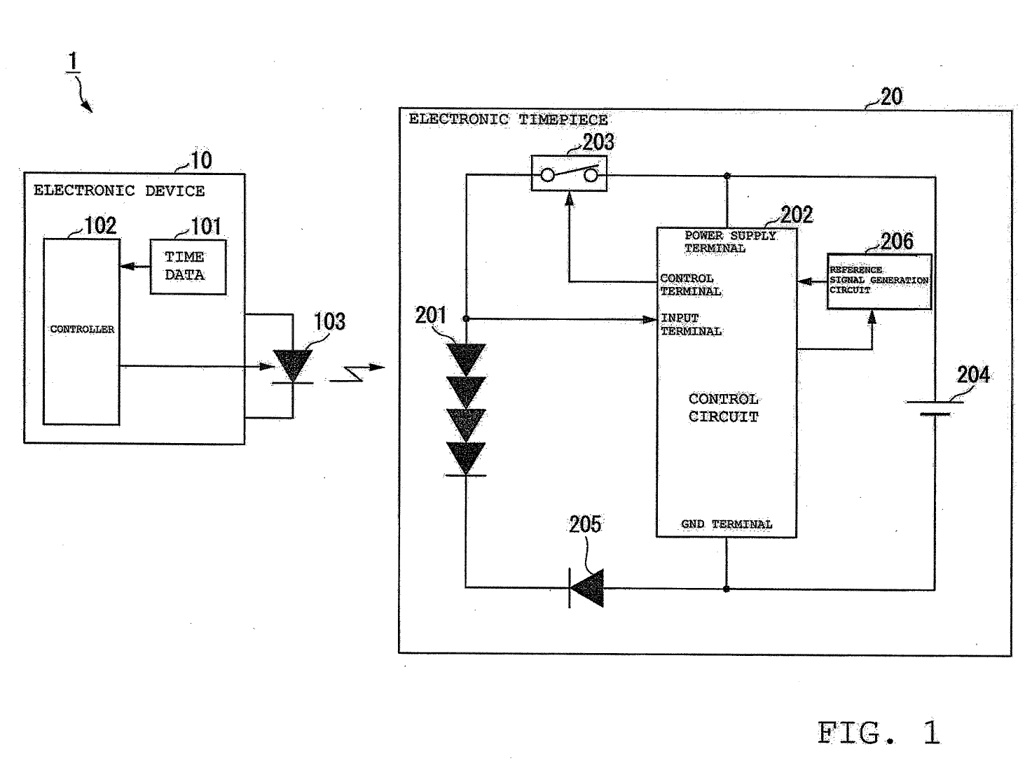

Hereinafter, an embodiment of the present invention will be explained with reference to the drawings. FIG. 1 is a schematic view showing a configuration of a communication system 1 according to the embodiment. In the shown example, the communication system 1 includes an electronic device 10 (first electronic device) and an electronic timepiece 20 (second electronic device). The electronic device 10 is an electronic device such as a smartphone, a cellular phone device or a tablet terminal. In the shown example, the electronic device 10 includes a time data acquisition part 101, a controller 102 and a light source 103.

The time data acquisition part 101 acquires the current date and time (the current time (hour, minute, second) and the current date (year, month, day)). For example, the time data acquisition part 101 uses a method of acquiring the current date and time by having an access to a time server on Internet, a method of acquiring the current date and time by using GPS (Global Positioning System) and a method of acquiring the current date and time from a control signal from a base station. Any method can be applied as the method of acquiring the current date and time.

The controller 102 performs control of respective parts included in the electronic device 10. The controller 102 generates time data for correcting the time of the electronic timepiece 20 based on the current date and time acquired by the time data acquisition part 101. Then, the controller 102 outputs (transmits) the generated time data which is transmission data by using the display part 103 as an optical signal.

When transmitting the transmission data by using the display part 103, the controller 102 transmits a communication start signal first, then, transmits a transmission data signal indicating the transmission data after transmitting a transmission-frequency measurement signal. The communication start signal is a signal for notifying the start of communication by the optical signal. The transmission-frequency measurement signal is a signal for measuring a transmission frequency of the transmission data signal, which is a signal of 2 or more bits in which “0” and “1” are repeated in each bit.

The display part 103 is a liquid crystal display or an organic EL (Electro-luminescence) display. The light source 103 operates as a transmission part which transmits the optical signal to the electronic timepiece 20. The optical signal is transmitted with the refresh rate which indicates the frequency of scanning or rewriting of a display, namely, the number of refresh times per a unit time normally by using Hertz (Hz) as a unit.

The electronic timepiece 20 is a timepiece which displays time in analog display. In the shown example, the electronic timepiece 20 includes a solar battery 201, a control circuit 202, a switch 203, a secondary battery 204, a diode 205 and a reference signal generation circuit 206.

The solar battery 201 operates as a power generation part which converts received light (sun, illumination and the like) into electric energy in a charging period. The solar battery 201 also performs optical communication with the electronic device 10 and operates as a receiving part which receives an optical signal from the electronic device 10 in a communication period. The charging period and the communication period will be described later.

The control circuit 202 also performs control of respective parts included in the electronic timepiece 20. The control circuit 202 performs charging control to the secondary battery 204 by the solar battery 201. The control circuit 202 also performs control to prevent overcharge of the secondary battery 204. The control circuit 202 further performs optical communication by using the solar battery 201. For example, the control circuit 202 is operated by the power outputted by the secondary battery 204 connected to a power supply terminal and a GND terminal. At this time, the control circuit 202 detects an output voltage of the secondary battery 204 to determine a charging state (full charge, overcharge and the like) of the secondary battery 204 and to control predetermined charge control. For example, the control circuit 202 performs ON/OFF control of the switch 203 by a control signal outputted from a control terminal in accordance with the charging state of the secondary battery 204. Accordingly, the control circuit 202 connects the solar battery 201 to the secondary battery 204 to charge the secondary battery 204. The control circuit 202 also prevents overcharge to the secondary battery 204 by cutting the connection between the solar battery 201 and the secondary battery 204.

The control circuit 202 also outputs a switch control signal based on a reference signal outputted by the reference signal generation circuit 206 to perform ON/OFF control of the switch 203. Accordingly, the control circuit 202 performs connection between the solar battery 201 and the secondary battery 204 as well as performs separation between the solar battery 201 and the secondary battery 204.

The control circuit 202 (controller) further detects an output voltage of the solar battery 201 inputted to an input terminal in the communication period and converts the detected voltage into an electric signal to receive transmission data transmitted from an external device (the electronic device 10 in the embodiment) by the optical communication. Then, the control circuit 202 specifies the transmission frequency of the transmission data based on the transmission-frequency measurement signal received before the transmission data, and receives the transmission data based on the specified transmission frequency. Then, the control circuit 202 corrects time indicated by a pointer based on time data as the transmission data.

The switch 203 performs connection between the solar battery 201 and the secondary battery 204 as well as performs separation between the solar battery 201 and the secondary battery 204 based on the switch control signal inputted from the control circuit 202. The secondary battery 204 supplies the power to respective parts included in the electronic timepiece 20. The diode 205 prevents reverse flow of electric current with respect to the secondary battery 204. The reference signal generation circuit 206 includes an oscillator circuit (for example, 32 kHz) and a divider circuit, which generates a reference signal of, for example, 1 Hz.

Next, a communication method between the electronic device 10 and the electronic timepiece 20 will be explained. In the embodiment, the electronic device 10 transmits data by using the display part 103. For example, the electronic device 10 lights up the light source 103 when transmitting “1” and darken the light source 103 when transmitting “0”. For example, when the light source 103 is the liquid crystal display or the organic EL display, the liquid crystal display or the organic EL display as the light source 103 is lit up by changing the color to a bright color (for example, white) when transmitting “1”, and the liquid crystal display or the organic EL display as the light source 103 is darkened by changing the color to a dark color (for example, black) when transmitting “0”. The electronic timepiece 20 received data by using the solar battery 201. For example, the control circuit 202 of the electronic timepiece 20 determines that the electronic timepiece 20 has received “1” when the solar battery 201 receives light and generates a voltage, and the control circuit 202 of the electronic timepiece 20 determines that the electronic timepiece 20 has received “0” when the solar battery 201 does not generate a voltage.

When the solar battery 201 and the secondary battery 204 are connected, it is difficult to accurately determine the voltage generated by the solar battery 201 due to the output voltage of the secondary battery 204. Accordingly, in the embodiment, the switch 203 is controlled to separate the solar battery 201 and the secondary battery 204 at the time of receiving data for detecting the voltage generated by the solar battery 201 accurately. A period in which the solar battery 201 and the secondary battery 204 are separated is referred to as the “communication period”.

In a period other than the communication period, the switch 203 is controlled to connect the solar battery 201 and the secondary battery 204. A period in which the solar battery 201 and the secondary battery 204 are connected is referred to as the “charging period”. Accordingly, it is possible to receive data more accurately in the communication period.

It is also possible to perform setting so that the secondary battery 204 is not charged during the communication period. Accordingly, it is preferable that the communication period is short. Therefore, the charging period is set at a normal time and short communication periods are periodically set in the electronic device 20. Then, the electronic timepiece 20 continues to be in the communication period until receiving a transmission data signal when receiving a communication start signal from the electronic device 10 during the short communication period. On the other hand, the electronic timepiece 20 becomes in the charging period in the case where the transmission start signal is not received from the electronic device 10 during the communication period.

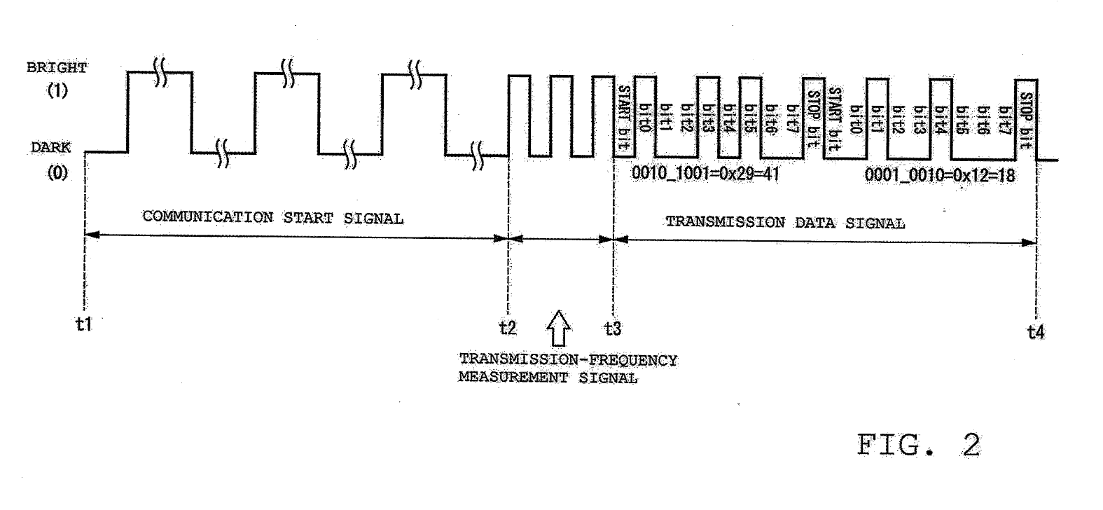

FIG. 2 is a timing chart showing transmission timings of the communication start signal, the transmission-frequency measurement signal and the transmission data signal to be transmitted to the electronic timepiece 20 by the electronic device 10. In the drawing, an example of transmitting transmission data (0x29, 0x12) is shown.

As shown in the drawing, when transmission data is transmitted, the electronic device 10 transmits communication start signal repeating the dark color and the bright color of the light source 103 at fixed intervals first and repeating “0” and “1” (time t1 to time t2). After that, the electronic device 10 transmits the transmission-frequency measurement signal repeating the dark color and the bright color of the light source 103 in the same cycle as the transmission cycle of transmission data and repeating “0” and “1” for a given number of times (time t2 to time t3). The given number of times is the predetermined number of times, and the electronic timepiece 20 side also stores the given number of times in advance. Accordingly, the electronic timepiece 20 can specify the end timing of the transmission-frequency measurement signal and the start timing of transmission data. The given number of times can be set arbitrarily.

After that, the electronic device 10 transmits transmission data by changing the color of the light source 103 to the dark color and the bright color (time t3 to time t4). As the light source 103 is the liquid crystal display, the organic EL display or the like, the transmission cycle of transmission data is a cycle based on the refresh rate of the light source 103. Accordingly, the transmission cycle of transmission data differs according to the type of the light source 103 included in the electronic device 10.

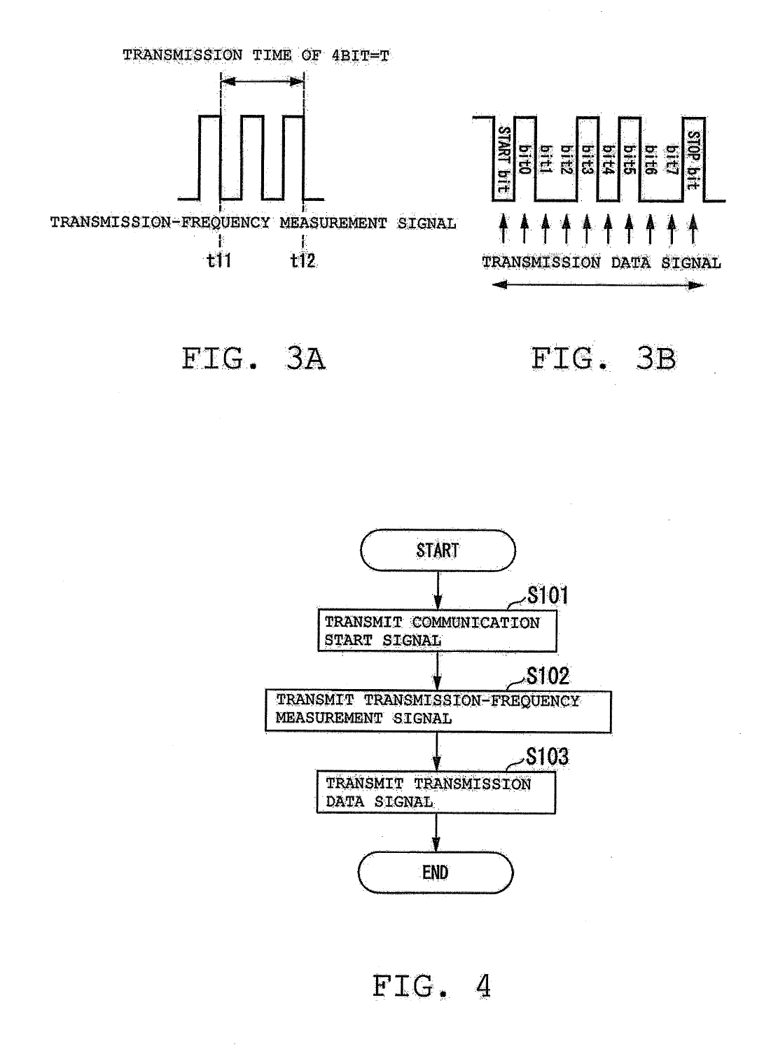

FIGS. 3A and 3B are views for explaining a method of specifying the transmission frequency in the electronic timepiece 20. When the electronic timepiece 20 receives the communication start signal during the communication period, the electronic timepiece 20 continues to be in the communication period and becomes in a waiting state for receiving the transmission-frequency measurement signal. When the electronic timepiece 20 receives the transmission-frequency measurement signal, the electronic timepiece 20 specifies the transmission frequency of the transmission data signal based on the received transmission-frequency measurement signal. As described above, the transmission-frequency measurement signal is a signal having the same cycle as the transmission data. Therefore, the transmission frequency of the transmission data can be specified by specifying the transmission frequency of the transmission-frequency measurement signal.

Specifically, the electronic timepiece 20 measures a receiving time T (time t11 to time t12) of given bit (4-bit in the shown example) in the transmission-frequency measurement signal (FIG. 3A). Then, the electronic timepiece 20 divides the given bit number (4-bit in the shown example) by the measured receiving time T, thereby specifying the transmission frequency (4/T in the shown example). Here, the electronic timepiece 20 specifies the transmission frequency by measuring a cycle (a width of “0” or “1”) of switching between “0” and “1”, however, a reaction speed at the time of switching from the dark color “0” to the bright color “1” may differ from a reaction speed at the time of switching from the bright color “1” to the dark color “0”. Accordingly, there is a danger that the correct time is not measured when measuring time between an edge from the dark color “0” to the bright color “1” and an edge from the bright color “1” to the dark color “0”. Therefore, it is desirable to specify the transmission frequency by measuring time between two or more edges from the dark color “0” to the bright color “1” and two or more edges from the bright color “1” to the dark color “0” . Accordingly, the transmission-frequency measurement signal preferably includes two (4-bit) or more pairs of “0” and “1”.

Subsequently, the electronic timepiece 20 receives the transmission data signal by using the specified transmission frequency (4/T in the shown example) as a data fetching cycle per 1-bit (FIG. 3B). That is, the electronic timepiece 20 determines that 1-bit data is stored in the transmission data signal in each transmission frequency (4/T in the shown example). The electronic timepiece 20 also extracts data for 1-byte from the transmission data signal by detecting “START bit” and “STOP bit”. In the shown example, the electronic timepiece 20 extracts “0010_{—}1001”=“0x29”=“41” and “0001_{—}0010”=“0x12”=“18” from the transmission data signal.

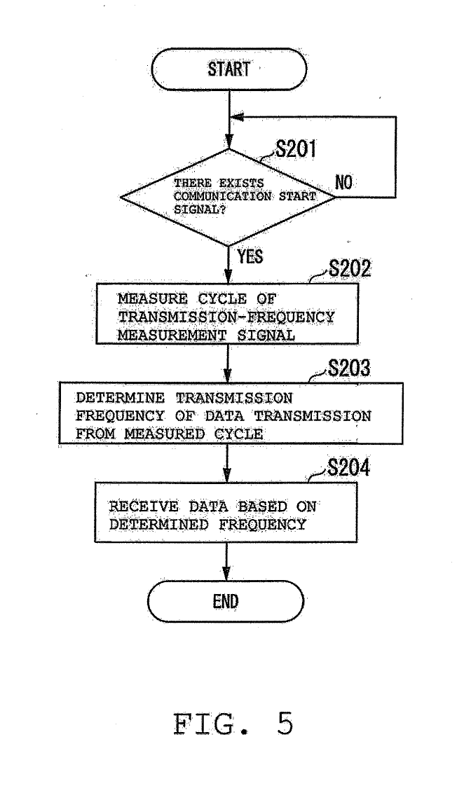

Next, a communication method in the communication system 1 will be explained with reference to FIG. 4 and FIG. 5. FIG. 4 is a flowchart showing a processing procedure of communication processing executed by the electronic device 10 according to the embodiment. The electronic device 10 executes the processing shown in the drawing at the time of transmitting the transmission data.

(Step S101) The controller 102 controls the light source 103 to transmit the communication start signal for a fixed period. After that, the process proceeds to Step S102.

(Step S102) The controller 102, after completing the transmission of the communication start signal, controls the light source 103 to transmit the transmission-frequency measurement signal with the same transmission frequency as the transmission data signal. After that, the process proceeds to Step S103.

(Step S103) The controller 102 controls the light source 103 to transmit the transmission data signal. After that, the process ends.

FIG. 5 is a flowchart showing a processing procedure of communication processing executed by the electronic timepiece 20 according to the embodiment. The electronic timepiece 20 executes the processing shown in the drawing during the communication period.

(Step S201) The control circuit 202 determines whether the communication start signal has been received or not through the solar battery 201. When the control circuit 202 determines that the communication start signal has been received, the process proceeds to Step S202. When the control circuit 202 determines that the communication start signal has not been received, the processing of Step S201 is executed again.

(Step S202) The control circuit 202 receives the transmission-frequency measurement signal through the solar battery 201 and measures the cycle of switching between “0” and “1” in the received signal for measuring the frequency. After that, the process proceeds to Step S203.

(Step S203) The control circuit 202 determines the transmission frequency of the transmission data signal from the measured cycle. After that, the process proceeds to Step S204.

(Step S204) The control circuit 202 receives transmission data through the solar battery 201 based on the determined transmission frequency. After that, the process ends.

As described above, when the transmission data signal is transmitted, the controller 102 of the electronic device 10 transmits the communication start signal first, then, transmits the transmission data signal after transmitting the transmission-frequency measurement signal in the embodiment. When the control circuit 202 of the electronic timepiece 20 receives the communication start signal, the control circuit 202 continues to be in the communication period and becomes in a waiting state for receiving the transmission-frequency measurement signal. Then, when the control circuit 202 receives the transmission-frequency measurement signal, the control circuit 202 specifies the transmission frequency by measuring the cycle of “0” and “1” in the received transmission-frequency measurement signal. Then, the control circuit 202 receives transmission data based on the specified transmission frequency. Accordingly, the electric timepiece 20 can specify the transmission frequency of the transmission data automatically and can receive the transmission data normally even when the transmission frequency of the electronic device 10 is not specified in advance.

The entire or part of the functions of respective parts included in the electronic device 10 or the electronic timepiece 20 in the above embodiment may be realized by recording a program for executing these functions in a computer-readable recording medium and reading the program recorded in the recording medium in a computer system to be executed. Note that the “computer system” in this case includes hardware such as OS and peripheral devices.

The “computer-readable recording medium” indicates a portable medium such as a flexible disc, a magneto-optical disc, a ROM or a CD-ROM, or a storage unit such as hard disk built in the computer system. The “computer-readable recording medium” may also include a medium dynamically holding the program for a short time such as a communication cable used when transmitting the program through a network such as Internet or through a communication line such as a telephone line as well as a medium temporarily holding the program such as a volatile memory inside the computer system to be a server or a client in the above case. The above program may be also for realizing part of the above functions and may be realized by combining the above functions with a program already recorded in the computer system.

The embodiment of the present invention has been explained as described above. However, the present invention is not limited to the above embodiment and various alterations may occur within a scope not departing from the gist of the present invention.

For example, the explanation has been made by distinguishing the transmission-frequency measurement signal from the transmission data in the above embodiment, however, the present invention is not limited to this, and part of the transmission data can be configured as the transmission-frequency measurement signal. In this case, for example, transmission can be performed by setting the first bit (b0, b1, b2, b3) of transmission data as the bit for measuring the frequency so as to be surely 1010, and the receiving side can remove the part of the bit to receive data.

Although the electronic timepiece 20 performs switching between the charging period and the communication period in which the optical communication is performed in the above embodiment, the present invention is not limited to this, and the charging and optical communication may be performed at the same time without separating the charging period and the communication period in which the optical communication is performed.

Also in the above embodiment, the explanation has been made by using the example in which time data is transmitted as transmission data, however, the present invention is not limited to this, and data other than time data may be transmitted. For example, data of alarm time, timer setting values and so on may be transmitted as transmission data.

The electronic timepiece 20 repeats the charging period and the communication period in which the optical communication is performed in the given cycle in the above embodiment, however, the present invention is not limited to this, and it is also preferable that the charging period and the communication period are switched by controlling the switch 203 in accordance with the charging state of the secondary battery 204.

Although the electronic timepiece 20 receives the optical signal by the solar battery 201 in the above embodiment, the receiving part which receives the optical signal is not limited to this, and devices which can detect the brightness such as an illuminance sensor may be applied.

Also in the above embodiment, a 5-bit signal is used for the transmission-frequency measurement signal, however, the present invention is not limited to this, and the signal preferably includes at least one pair of “0” and “1” (2-bit) or more.

Also in the embodiment, “1” and “0” are represented by the bright color and the dark color (for example, white and black) in the optical signal, however, the present invention is not limited to this, and “0” and “1” can be represented by light emitting intensity. In this case, it is desirable to turn on the light and turn off the light, but it is sufficient that light emitting intensity differs such as light emission with a lower intensity and light emission with a higher intensity. It is desirable that the bright color is “white” and the dark color is “black” when “1” and “0” are represented by the bright color and the dark color, however, other colors may be applied.

Although the electronic device 10 transmits the communication start signal at the time of starting communication in the above embodiment, the present invention is not limited to this, and it is also preferable to transmit the transmission-frequency measurement signal without transmitting the communication start signal. In this case, the electronic timepiece 20 is preferably in the waiting state for receiving the transmission-frequency measurement signal before starting communication so as to receive the transmission-frequency measurement signal.

The explanation has been made by using the liquid crystal display, the organic EL display or the like as the example of the light source 103 in the above embodiment, however, the present invention is not limited to this. For example, devices which emit light such as a light emitting diode may be applied as the light source 103.

What is claimed is:

1. A communication system comprising:
a first electronic device; and
a second electronic device,
wherein the first electronic device includes
a transmission part transmitting an optical signal, and
a controller transmitting a transmission-frequency measurement signal for measuring a transmission frequency of data from the transmission part and transmitting the data from the transmission part, and
the second electronic device includes
a receiving part receiving the optical signal, and
a controller specifying the transmission frequency of the data based on the transmission-frequency measurement signal received by the receiving part and receiving the data by the receiving part based on the specified transmission frequency.

2. The communication system according to claim 1,
wherein the first electronic device has a display part which is refreshed with a given refresh rate,
the display part functions as the transmission part which transmits the optical signal including time information,
the transmission-frequency measurement signal is transmitted with the refresh rate, and
the receiving part specifies the refresh rate as the transmission frequency.

3. The communication system according to claim 1,
wherein the transmission-frequency measurement signal is a signal having the same cycle as the data.

4. The communication system according to claim 1,
wherein the controller of the first electronic device transmits a communication start signal notifying the start of communication before transmitting the transmission-frequency measurement signal from the transmission part.

5. The communication system according to claim 1,
wherein the transmission-frequency measurement signal is a signal of 2 or more bits in which “0” and “1” are repeated in each bit, and
the controller specifies the transmission frequency by using the 2-bit signal as a unit.

6. An electronic device comprising:
a transmission part transmitting an optical signal; and
a controller transmitting a transmission-frequency measurement for measuring the transmission frequency of data from the transmission part and transmitting the data from the transmission part.

7. An electronic timepiece comprising:
a receiving part receiving an optical signal including time data; and
a controller specifying a transmission frequency of data including time data transmitted from another electronic device based on a transmission-frequency measurement signal for measuring a transmission frequency received by the receiving part and receiving the data based on the specified transmission frequency by the receiving part to correct time by the data.

8. A communication method in a communication system including a first electronic device and a second electrode device, comprising the steps of:
performing control to transmit a transmission-frequency measurement signal for measuring a transmission frequency of data and to transmit the data by using a transmission part which transmits an optical signal by the first electronic device; and
performing control to specify the transmission frequency of the data based on the transmission-frequency measurement signal received by a receiving part which receives the optical signal and to receive the data by the receiving part based on the specified transmission frequency by the second electronic device.
